(19) United States
(12) Patent Application Publication
(10) Pub. No.: US 2015/0371143 A1
(43) Pub. Date: Dec. 24, 2015

(54) METHOD FOR IDENTIFYING COUNTRIES VULNERABLE TO UNREST

(71) Applicant: Nicole Sponaugle, Springfield, VA (US)

(72) Inventor: Nicole Sponaugle, Springfield, VA (US)

(21) Appl. No.: 14/311,418

(22) Filed: Jun. 23, 2014

(51) Int. Cl. G06N 5/04; G06N 99/00

(52) U.S. Cl. CPC G06N 5/048; G06N 99/005

(57) ABSTRACT

A method for measuring and scoring susceptibility to social unrest in a country or region is disclosed. Data is collected regarding socioeconomic, political, demographic or other relevant conditions within the geographic area, a set of key indicators of possible social unrest is provided, the collected data is standardized across the indicators, performance level is calculated for each of the indicators, the collected data for each indicator within the geographic area is assigned a score based on the measurement of each indicator, and an overall score for the indicators is determined.

### TECHNICAL FIELD OF THE INVENTION

The present invention relates to the field of risk analysis.

### BACKGROUND OF THE INVENTION

Existing private-sector, government and academic predictive instability models are currently unsatisfactory when it comes to accurate predictions of unrest in givers countries. For example, these models were unable, to accurately forecast the far-reaching impact of the Arab Spring, a wide-ranging series of societal revolutionary movements that resulted in the nearly simultaneous overthrow of several governments and much sudden destabilization in the Middle East region.

The scope and impact of massive societal upheaval as part of the Arab Spring caught both public organizations and private businesses off guard. Countries that looked prosperous and stable on the surface, on a macro level (for example, Tunisia, Bahrain, and Oman) were nonetheless affected to varying degrees by social unrest. Additionally, a lack of understanding of the regional implications of the Arab Spring resulted in continuous surprises as unrest, spilled over into other countries, destabilizing the North African & Middle Eastern regions. This situation created an uncertain diplomatic, security and investment environment.

The Stimson Center., a non-profit non-partisan think tank, conducted a comprehensive review in 2011 of a broad range of academic, non-profit and private sector approaches and methodologies. Its overarching conclusion was that most experts did not predict the extent, the timing, and the spread of societal unrest in the Middle East region leading up to the Arab Spring. The revolution from below that came about on the streets of the Middle East in late 2010/2011 was not anticipated, because few were looking for it and they had not focused on Tunisia, the country that served as the starting point. Further, few had anticipated a popular uprising that brought the middle and working class onto the streets, or were properly set op to follow popular or street sentiment. The Stimson Center's study further concluded, that the commercial risk consulting sector, despite being specifically tasked to do so, had no more favorable results predicting the unrest than the public sector, slating that none of the risk consultants interviewed for its study claimed any insight into the nature and timing of Arab Spring events.

To the extent that there were some correct predictions, these were primarily focused on Egypt and did not account for widespread social unrest, in other nations, such as Tunisia, Libya, or Syria. Further, these models provided little comprehensive understanding of societal trends on a cross-regional, much less global, level.

This failure to foresee or warn of such a wide-ranging event as the Arab Spring is disturbing enough in a world where a proper picture of international situations is so critical. However, an extra dimension of concern is added when one considers that these events occurred in the Middle East, a strategic and resource-rich region that is perhaps the roost studied, focused-upon and modeled area of the world for such does to instability.

The implications of the continued, failure to understand the socio-economic conditions predisposing countries to such unrest can have dire consequences. Unease, for example, brought about by lack of understanding could cause the private and public sector to overreact in the event of future unrest. For example, the 2013 protests in Brazil and Turkey brought about more concern, uncertainty and speculations about impending instability in a post-Arab Spring climate, concerns that proved to be unfounded, than they otherwise would have. Further, international resources like aid and diplomacy are limited, so that the most, efficient use of these resources is critical.

Finally, the correlation between improvements in socio-economic conditions and social stability is not necessarily a positive and linear one. Lack of understanding of these subtle connections may result in misallocation of resources and the pursuit of governmental policies and investment strategies that promote rather than avert societal instability.

Current instability models and related Indices tend to have a narrow and exclusive locus that can miss important factors. Their focus leads to be exclusive on either particular economic sectors of interest to international corporations or on a top-down viewing of governmental centers of powers, ruling elites and key decision makers. Updating of these already-limited models on a less than annual basis may be insufficient as well Another weakness of these models is that they have a country-specific focus, obtaining and analyzing data nation by nation. Yet in the real world, and as the Arab Spring clearly showed, people of different nations interact with each other, and react to events and news in other countries. The national focus of data and modeling comes at the expense of understanding cross-regional or global trends, and vice versa. With the advent of the internet and other advanced communications, this trend is likely to increase, so that models that do not take this into account will become increasingly erroneous.

In addition, instability can occur for multiple reasons. There can be political unrest having to do with dissatisfaction with a specific person or group in power, or societal unrest relating to general demographic and socio-economic situations, or some mixture of both. Though this distinction creates differing sources of unrest, none of the existing models appear to draw this distinction between societal unrest and political instability. Another major factor affecting the likelihood of destabilizing unrest is its duration. The longer unrest continues, the more potential it has to destabilize and spill over into other countries, yet this is rarely accounted for.

Furthermore, the current models tend to be directed towards countries of concern fey experts, who then identify which particular models to apply, rather than the models identifying countries of concern and directing experts towards them. These models heavily rely on input by subject-matter experts/analysts to support the models' operations. Moreover, some models depend on subject-matter expertise to identity the key indicators to be applied and to weigh them accordingly. This expert-driven approach seriously limits the predictive utility of current models as it reinforces existing biases and conclusions at the expense of identifying and recognizing the significance of newly-emerging factors.

Therefore, there is a need for an improved method, with improved predictive capabilities, tor providing a bottom up perspective on a country or region's susceptibility to social unrest by gauging which countries are becoming more or less vulnerable to massive societal upheaval and identifying specific socio-economic areas that warrant continuous monitoring so that limited international resources can be allocated more efficiently.

### SUMMARY

These and other objects are achieved by the method for identifying countries susceptible to severe unrest or overthrow herein.

A group of key indicators of possible social unrest are pre-selected and assigned weights. The indicators and weights of indicators are based upon the latest data concerning countries worldwide. The selection of these indicators is empirical and based, on their historical presence in countries that have experienced societal upheaval to varying degrees. Primary indicators are those indicators that had a significant correlation to the occurrence of massive societal upheaval, resulting in an overthrow of government in a majority of the countries. Secondary indicators are those that have been found to have some impact, though not as great as primary indicators.

Next is the collection of data. The reported data is standardized across the indicators to adjust for differences in methods of reporting by organization and the type of data being conveyed.

A performance level is calculated for each of the indicators, by, for example, placing the measured score on a pre-determined scale for comparison.

Each of the indicators are individually measured for each country based on the most current data added for each indicator for that country, and an indicator score based on the measurement is assigned. Following this, the score of the indicators for the country can be quantified together to determine an overall score for the indicators of the country.

After an indicator score is arrived at the specific scores of a country across the multiple indicators can be compared to previous data and correlations between the indicators themselves when they arc at certain levels relative to each other. An instability metric is calculated and assigned to the country. If the weighted score is compared to already-known scores for countries, the country can be placed in an appropriate position in a pre-determined scale of probable instability. The weighted score can also be compared to a pre-determined “threshold score.” The more a country exceeds the “threshold score, the more susceptible the country is to social unrest. It can then be determined how susceptible the country is to instability and overthrow.

Beyond a single country, the method is capable of providing Insight into the stability of multiple countries or even an entire region. The method can be re-run for as many countries as desired. Additionally, foe potential for “spill over” or unrest moving from one place to another can be calculated and potential hot spots found in advance. The sustainability of the unrest can also be calculated and incorporated into the overall data picture.

### BRIEF DESCRIPTION OF THE DRAWINGS

FIG. 1 is a schematic diagram of an embodiment of the present invention.

FIG. 2 is a schematic diagram of another embodiment of the present invention.

FIG. 3 is a schematic diagram of a further embodiment of the present invention.

### DETAILED DESCRIPTION OF PREFERRED EMBODIMENTS

Other objects, features and advantages of the invention will become apparent from a consideration of the following detailed description and the accompanying drawings. The following descriptions are made referring to the figures, wherein like reference number refer to like features throughout this description.

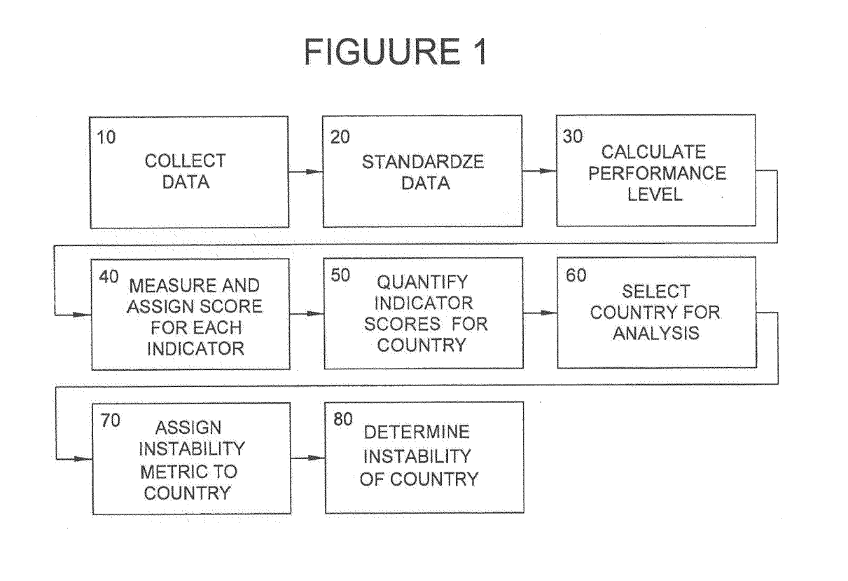

Several exemplary, though not exclusive, embodiments of the present invention are shown in FIG. 1-3. Turning to FIG. 1, a method is shown that can be used to analyze multi-factor data and assess the probabilities of unrest in a country or region due to socio-economic, political or other factors, or an interrelationship between these elements.

A group of key Indicators of possible social unrest have been pre-selected and assigned weights. The indicators and weights of indicators are based upon the latest data concerning countries that have or have not had civil unrest or revolution. The selection of these indicators is empirical and based on their quantified presence in countries that previously experienced social unrest. Those indicators found to have a correlation, negative or positive, to unrest such as general oppression (positive correlations) or access to fresh water (negative correlations) are included. Possible indicators found to have little or no correlation to social unrest, such as, e.g., life expectancy, ate systematically excluded.

Indicator correlations are periodically updated based on new instances of social unrest and availability of the most current data. In this embodiment for example, an in-depth empirical study of the latest data from ten Arab Spring countries was undertaken of 16 possible indicators to determine which correlated to the real-world unrest.

Those that correlated in the Arab Spring countries were included and those that did not were not included. It has been found that the indicators with the strongest correlations tend to be those concerning fundamental social, economic, and political conditions of a given country. In this embodiment, 12 key indicators have been found to have a correlation.

These appropriate indicators are selected. Further, the correlating indicators may be selected and assigned weights based on their correlation relative to other indicators. Two levels of overall correlation have been observed, and the correlating indicators are therefore divided into two general types of indicators, primary and secondary.

The primary indicators are those indicators that were necessarily present for countries with a resultant overthrow of their government. The secondary indicators are those that have been found to have some impact, though not as great as primary indicators. Secondary indicators are those which are often, but not necessarily, elevated in countries with overthrow or unrest. Primary indicators are more influential, so are assigned a higher weight relative to secondary indicators. In this embodiment, six primary and six secondary indicators were observed and are used. The weights are based on the prevalence of each indicators in countries that experienced significant social unrest. For example, in the aforementioned study of ten Arab Spring countries, the primary Indicators for social unrest were present in 80-100% of the countries that were analyzed; the secondary indicators were present in 50-70 percent of the countries analyzed.

The empirically observed primary indicators in this embodiment are (1) degree of oppression by the government, (2) freshwater availability per capita, (3) education level of the population, (4) press freedom, (5) proportion of youth to adult population, and (6) rate of urban growth. The six observed secondary Indicators are (7) gender inequality, (8) perceived corruption, (9) degree of failed state/lack of basic governmental services, (10) gross national income per capita, (11) growth rate of human development in a country, and (12) arable land per capita.

Next is the collection of data 10. Periodically, relevant data is released by reputable non-governmental, international, and governmental organizations regarding various conditions and factors in countries of interest, such as, e.g. socio-economic, political and demographic data. The data is collected 10 for processing. In this embodiment, the data that is being used for the method is publicly available and created by a variety of reputable sources such as the World Bank, the United Nations, and various non-governmental organizations such as Reporters Without Borders, Freedom House, and Transparency International.

Next, the reported data is standardized across the indicators 20, to adjust for differences in methods of reporting by organization and the type of data being conveyed. Standardization is achieved by determining an average value for each of the 12 indicators and using this average value to establish four value ranges: severe, poor, average, and above average. After the data is standardized, each piece of data is entered into the appropriate indicator categories, thereby updating each category.

After the indicator is measured and a weighted score assigned, a performance level is calculated 30 for each of the indicators by means suitable in the art. In this embodiment, the measured score is placed on a predetermined scale for comparison. The predetermined scale consists of the typical socio-economic profiles (consisting of the 12 indicators) of countries that have experienced varying degrees of social unrest. A country's susceptibility to societal upheaval is determined by how closely it matches or departs from the typical socio-economic profile across the 12 indicators.

Next, each of the indicators, the 12 named indicators in this embodiment, are individually measured for each country of possible interest based on the most current data added for indicator for that country, and an indicator score based on the measurement assigned 40. For an example, data concerning the level of government oppression in Tunisia would be quantified in accordance with the above-referenced value ranges (severe, poor, average, and above average) to provide a measurement of this indicator. Then a score based upon this measure is provided 40.

Following this, the score of the indicators for each country can be quantified together to determine an overall score for the indicators of each country 50. If a further analysis is to be done of interrelationships of factors, the scoring of indicators 50 for each country is a preliminary step.

Then, a country is selected for analysis 60. Typically, a single country is selected and analysed 60 at a time. However, the method is repeatable and can be used to analyse a number of individual countries, or the analyses of multiple countries can be combined to provide a regional analysis.

As part of the country analysis 60, the specific scores of a country across the multiple indicators relative to each other can be compared to known specific correlations between the indicators themselves when they are at certain levels relative to each other. If a similar relationship is found between the relative positions of indicators, the overall score can be recalculated upward or downward, as appropriate

By way of explanation, particularly high instability score for a pair of indicators may exacerbate each other, so that a higher score than would otherwise be assigned to the country may be appropriate. On the other hand, there is not always a direct correlation between indicator scores and unrest. Different scores across indicators can interact to create conditions more likely for unrest. For example, testing of the indicators with the method herein have shown that the widely-held view that any socio-economic improvements increase the likelihood of social stability is not entirely correct. Improvement in some specific sectors without accompanying improvements in related sectors can, in fact, increase the chances for instability rather than decrease them. For example, an increase in education without a corresponding increase in other areas can create instability. These relationships can be correlated to data on already-known relationships between indicators and accounted for in calculation for unrest potential. Finding and using these correlations among these indicators to each other provides a more nuanced understanding of cross-sector trends and their implications on overall stability, as well as a more accurate model.

At this juncture, an instability metric is calculated and assigned to the country 70. This can be done in a number of ways. The weighted score for each country for the combination of indicators and weights can be compared either to already known weighted scores for multiple countries whose eventual levels of unrest are known, or compared to established quantitative threshold scores for countries that have had unrest or overthrow to arrive at a metric 70.

If the weighted score is compared to already-known scores for countries, the country can be placed in an appropriate position in a pre-determined scale of probable instability. The scale, for example, could have the positions “somewhat stable,” “unstable,” and “very unstable.

The weighted score can also be compared to a pre-determined “threshold score.” The threshold would be calculated based on criteria from comparison to previously gathered data. For example, and in this embodiment, “threshold scores” are pre-determined based on indicator data fern the Arab Spring countries. If the country score is above the “threshold score,” this country has the strong potential for societal instability and should be monitored. The more a country exceeds the “threshold score, the more susceptible the country is to social unrest.

Once a metric has been taken for a country 70, it can be determined how susceptible the country is to instability or overthrow 80. If a metric shows that a country may become unstable, this knowledge can be supplemented with expert analysis and opinion. Because the analysis relies initially on empirical data and not on these analyses, common biases from such reliance can be avoided, and the expertise better-directed.

Beyond a single country, the method is capable of providing insight into the stability of multiple countries or even an entire region. The method can be re-run for as many countries as desired to gain the fullness of picture necessary. During testing of this method, up to 177 countries were tested. Insight and knowledge into the stability of a region can be gained by calculating the stability of the countries in that region and either comparing this stability to other regions or to the same region at a time in the past, or both.

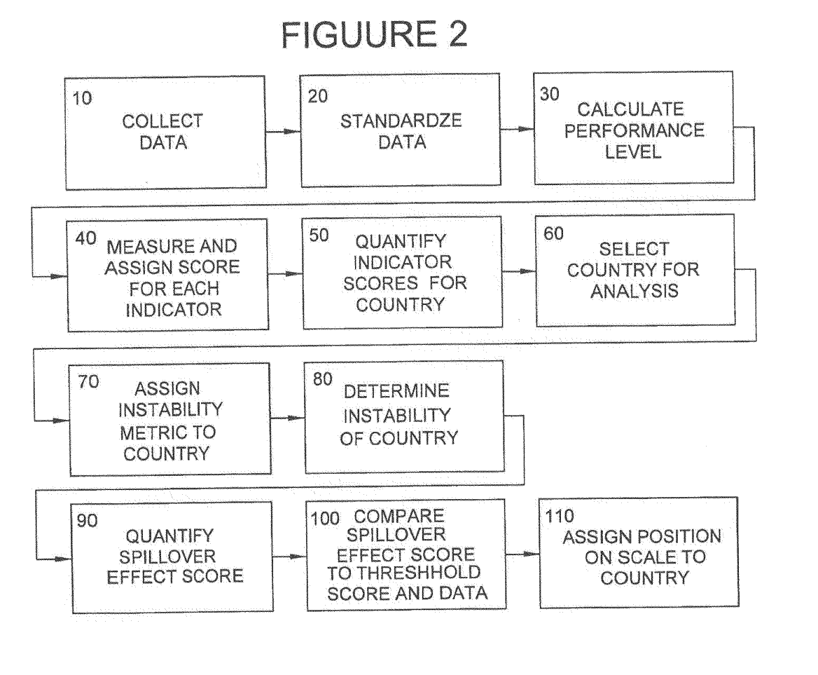

Turning to FIG. 2, the potential for “spill over” or unrest moving from one place to another can also be quantified and potential hot spots found in advance. After an instability score or placement on a scale is calculated for a country 80, its spillover effect score or metric is quantified 90.

The country is assessed in terms for potential spillover effect to other countries and a “spillover effect” score assigned 90, according to three pre-determined criteria which empirical findings have shown to have a direct correlation to spill over. These are 1) the country's assigned instability position or metric, as concluded in step 80, 2) the country's geographic proximity (i.e. shared borders) with other countries that have also been quantified as susceptible to societal unrest, and 3) the amount of flow of people between any two involved susceptible countries (from an immigration as well as emigration perspective). The higher the first and bordering country's instability metrics, the greater the border and geographic proximity and the greater the flow of people between the susceptible countries, the greater the potential is for unrest to move from one country to another. The data from the country is quantified in terms of data quantified previously from that and/or other countries concerning the same three criterions. The higher the score, the more likely is the phenomenon of spillover.

Next, the assigned spillover effect score is compared to a pre-determined “threshhold score,” 100. The threshold score is pre-calculated and determined based on related past data concerning instability and spillover. If the Spillover Score moves close to the threshold score, it should be considered cause for concern and if it surpasses it, more so. The more the Spillover Score exceeds the threshhold score, the more likely spread of societal unrest from one country of concern to another is. Based on this, the country is assigned a position on a scale regarding its potential to spread unrest 110.

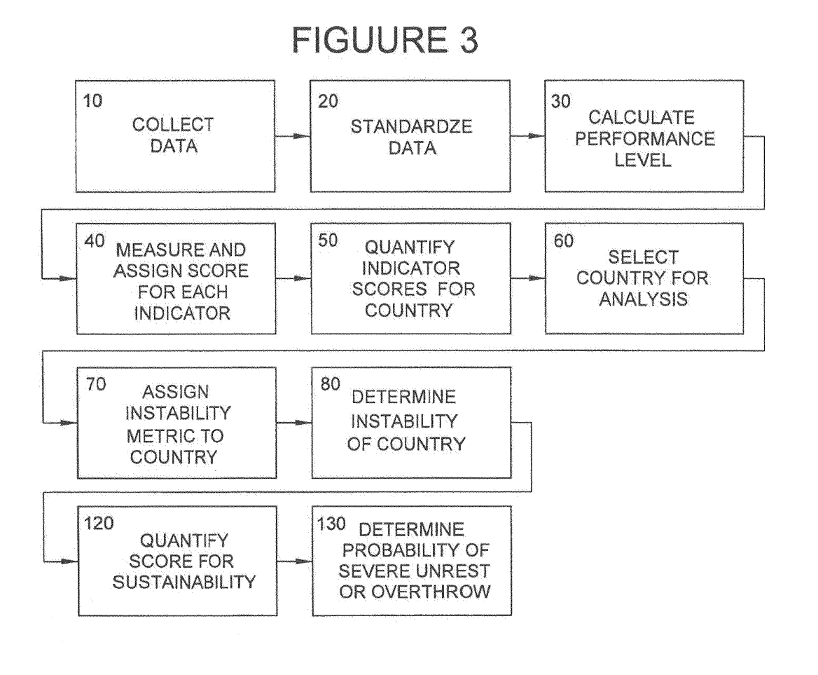

Turning to FIG. 3, another important factor affecting the depth of societal unrest and its potential to result in overthrow, the sustainability of unrest van be calculated and incorporated into the overall data picture as well. The more sustained unrest can be expected to be, the more likely it will result in overthrow of the government so that this score can provide important additional information.

After overall probability of a country having societal unrest based on indicator scores is quantified 80, if a country is identified as having strong potential for unrest, a secondary score for the sustainability, or length, of any possible unrest is quantified 120 to help determine the probable longevity of unrest.

In this step, quantified scores for the indicators for the country are compared to specific indicator scores from data for previous instances of unrest that have been pre-identified as correlating to sustainability. The indicators, relationships between them and weighted scores of a country can be compared to previous data from that and other countries and calibrated, comparing current conditions to those of countries which experienced prolonged or sporadic unrest and whether the societal unrest resulted in an overthrow of the governing authorities. For example, lowered educational opportunities and press freedom appear to correlate highly with sustained unrest, whereas youth and urban growth correlate highly with sporadic unrest. Based on this comparison, a score for sustainability is calculated and assigned 120.

Once a score is assigned 120, the probability of severe unrest or even overthrow of the government can be determined 130. Governments vulnerable to overthrow can be identified, intense analysis can be directed to any such developing situation, and whatever action is appropriate can be taken.

This method uniquely distinguishes between socio-economic conditions that fuel prolonged unrest and those that fuel sporadic unrest. This is of significant practical value because it provides the user with the nuanced understanding of which protests are likely to be destabilizing and which protests are unlikely to be so.

This measured and weighted method can be applied on a regional or global scale. In this embodiment, the method is shown for a single country, but data can be collected for as many countries as it is desired to study and quantify. Multiple countries can be evaluated using this method, to gain a picture of the situation in a contiguous area, regionally, or even globally. Countries and regions worldwide can be monitored and scored to show whether, overall, each is moving toward or away from such social instability. As a result, a comprehensive overview can be provided of countries that are highly susceptible, somewhat susceptible and not susceptible to social unrest.

The data to be input into the indicator models is updated at an appropriate interval to keep the data fresh and relevant. Updating is on an anneal basis in this embodiment, but may be annual, semi-annual quarterly or other.

### CASE STUDY

This empirical method was tested to identify countries most susceptible to social unrest within a time frame of two years or less from testing. Data was gathered and standardized and the method was used to provide quantified metrics of instability for 177 countries. The countries were analyzed and scored compared to previously-known data for countries that actually experienced sustained or sporadic societal unrest. The results were impressive. The method was found to demonstrate impressive accuracy in identifying countries that are at highest risk for social instability. All of the countries that the method identified to be at highest risk for sustained social unrest experienced such unrest within 1-2 years. These countries include Tunisia, Syria, Libya, Egypt, and Iraq. Moreover, countries such as Syria and Iraq were successfully identified by this method, even though they were widely considered by experts in the field as unlikely to experience widespread and sustained social unrest.

This method provides a number of benefits and advantages. It has been found, when applied, to provide 1-2 years of advanced warning regarding countries or regions primed for social unrest. The method herein, instead of insight into a single economic factor or country, can provide a global, regional or country-specific perspective, depending simply on which and how many countries it is applied to. Trends within selected countries can also be tracked over time, thereby offering a contextual and systematic understanding of improving or worsening trends in indicator areas such as social freedoms, quality of life, socio-economic opportunities, and resource pressures.

It is also sufficiently nuanced to shed light on whether improvements is particular sectors are sufficient, based on historical data, to have a stabilizing effect on a country as a whole or may inadvertently destabilize it.

By differentiating between prolonged and sporadic unrest, the method herein can further assist users with a comprehensive understanding of different types of unrest which—on the surface—may all look alike and identify which type is underway. This can prevent users from overreacting, mistaking a protest movement as more influential, far-reaching and destabilizing than it actually is.

The knowledge obtained by the method can be useful and even life-saving in a number of ways. First, is will aid users in making important resource allocation decisions. As an example, if the method unveils that a country or area is at or near a threshold so that it is primed for social unrest, commercial enterprises can be warned that these are unlikely to provide a suitable venture or investment climate, thereby averting possible disaster for these enterprises. On the other hand, identification of such countries may be helpful for the non-profit sector which may be specifically seeking to assist such countries with investment and aid allocation.

The method may also identify investment opportunities to users by highlighting sectors that are in need of improvement to stabilize a given country. In addition, it provides a cross-sectional perspective allowing the users to understand what the unifications of investing in a particular sector are on the other socio-economic sectors that are being monitored.

Finally, when operating in foreign cultures, it can be especially difficult for users to understand how sincere and effective a foreign government's policies are at ensuring domestic prosperity and stability. This method provides a quantitative evaluation of the effectiveness of a country's policies in promoting social stability, assisting users in differentiating between meaningful reforms and superficial policies with little or no effect on stability.

By this simple method and device, a user can more effectively identify and predict countries or areas of potential societal unrest or revolution. It is to be understood that while certain forms of the present invention have been illustrated and described herein, the expression of these individual embodiments is for illustrative purposes and should not be seen as a limitation upon the scope of the invention. It is to be further understood that the invention is not to be limited to the specific forms or arrangements of parts described and shown.

1. A Method for measuring and scoring susceptibility to social unrest in a geographic area, comprising the steps of:
collecting data regarding socioeconomic, political, demographic or other relevant conditions within the geographic area,
providing a set of at least two key indicators of possible social unrest
standardizing the collected date across the indicators,
calculating a performance level for each of the indicators,
measuring the collected data for each indicator within the geographic area and assigning a score based on the measurement of each indicator, and
determining an overall score for the indicators,
wherein the key indicators have a correlation to social unrest, and
wherein the correlation can be a positive or negative correlation, and
wherein the selection of the key indicators is based on empirical data.

2. A method according to claim 1, further comprising the steps of:
achieving standardization of data by determining an average value for each indicator and
establishing a set of at least four value ranges,
wherein the four value ranges are severe, poor, average, and above average.

3. A method according to claim 1, further comprising the step of entering each piece of collected data into an appropriate indicator category after the data is standardized.

4. A method according to claim 1, further comprising the steps of:
calculating the performance level for each of the indicators by placing the measured score on a pre-determined scale and
comparing the performance level against the predetermined scale.

5. A method according to claim 1, providing the further steps of assigning a weight to each key indicator.

6. A method according to claim 1, wherein at least two indicator have a correlation to each other.

7. A method according to claim 1, further comprising the step of dividing the key indicators into primary and secondary indicators,
wherein the primary indicators are those found to be necessarily present for countries susceptible to social unrest and secondary indicators are those found to have some impact on social unrest.

8. A method according to claim 7, wherein primary indicators are those found to have been present in 80-100% of areas that experienced significant social unrest according to the latest data collected, and secondary indicators are those found to have been present in 50-70% of areas that experienced significant social unrest.

9. A method according to claim 7, wherein the primary indicators are at least two of:
the degree of oppression by the government, freshwater availability per capita, education level of the population, press freedom, proportion of youth to adult population, and rate of urban growth.

10. A method according to claim 1, wherein the geographic area is a country, and comprising the further steps of:
selecting a country for analysis,
calculating an instability metric or score for the country,
determining the amount of susceptibility of the country to instability or overthrow.

11. A method according to claim 10, comprising the further step of analyzing at least one additional country.

12. A method according to claim 11, comprising the further step of combining the analysis of at least two countries to provide a regional analysis.

13. A method according to claim 10, comprising the further step of comparing the specific scores of a country across at least two indicators to known specific correlations between the at least two indicators based on previous data for the indicators, and either not recalculating the score or recalculating the score upward or downward.

14. A method according to claim 10, wherein the instability metric or score for the country is calculated by:
comparing a weighted score for each country for the at least two indicators to either a previously-known weighted score or a threshold score for at least one other country for past unrest.

15. A method according to claim 10, comprising the further step of: placing the country in an appropriate position within a pre-determined scale of probable instability.

16. A method according to claim 10, comprising the further steps of:
calculating the amount of instability of at least one additional country in the same region as the country and using the respective country scores together to obtain a stability level for the region in which the countries are located, and either comparing this regional stability to the stability of at least one other region or to the same region at a previous time.

17. A method according to claim 10, comprising the further steps of:
providing at least a second country such that there is a first country and at least a second country,
calculating a spillover effect score or metric for the at least two countries,
comparing the assigned spillover effect score or metric to a pre-determined threshold score,
wherein the threshold score is determined based on related past data concerning instability and spillover, and
assigning a position on a scale regarding the potential for spillover.

18. A method according to claim 17, wherein the higher the spillover score, the more likely unrest is to spread from the first country to the at least second country.

19. A method according to claim 17, wherein the spillover effect or metric from the country to a second country is calculated using any combination of:
the first country's assigned instability score or metric,
the first country's geographic proximity or amount of shared border with the second country, and the amount of flow of people between the two countries.

20. A method according to claim 10, further comprising the steps of:
calculating a secondary score for the sustainability of any possible unrest in the country, and
determining the probability of severe unrest or overthrow of the government of the country by comparing the specific score for sustainability of unrest to specific indicator scores from data for previous instances of unrest in either the country or another country or countries,
wherein the specific indicator scores have been pre-identified as correlating to sustainability.
